(19) United States
(12) Patent Application Publication
(10) Pub. No.: US 2014/0279484 A1
(43) Pub. Date: Sep. 18, 2014

(54) SYSTEM AND METHOD FOR VALIDATING RECEIVED CLEARING INFORMATION FOR IMPLEMENTING A GLOBAL ELECTRONIC FUNDS TRANSFER

(71) Applicant: BOTTOMLINE TECHNOLOGIES (DE) INC., Portsmouth, NH (US)

(72) Inventors: Nicole Pierrette Dwyer, Dover, NH (US); Nicholas Anthony Griffin, Dover, NH (US); Michael Alan Vigue, Wells, ME (US); Eric Campbell, Rye, NH (US)

(73) Assignee: BOTTOMLINE TECHNOLOGIES (DE) INC., Portsmouth, NH (US)

(21) Appl. No.: 13/837,192

(22) Filed: Mar. 15, 2013

(51) Int. Cl. G06Q 20/10

(52) U.S. Cl. CPC G06Q 20/108
USPC 705/42

(57) ABSTRACT

A system and method is presented for validating received required information (i.e., clearing information) for performing a global electronic funds transfer. The system and method generates a form for receiving the clearing information from a user. The form includes clearing information fields that are each configured to receive an element of clearing information. The form is updated based on validation rules. The validation rules (1) define a relationship between at least one of the clearing information fields and the clearing information received from the user and (2) specify acceptable values for the clearing information received by a given clearing information field. The received clearing information is analyzed in relation to the clearing information fields by applying the validation rules to adjudicate the clearing information received in the given clearing information field as acceptable or invalid.

### TECHNICAL FIELD

The present invention relates to providing financial transaction processing services, and more particularly, to a system and method for validating received clearing information for implementing a funds transfer.

### BACKGROUND

Banks and other financial institutions utilize websites to allow customers to obtain online access to their accounts. However, bank websites often lack support for less popular types of financial transactions. Infrequently performed transactions are often not supported, because it is not cost effective for banks to support diverse financial transactions due to a low volume of usage by customers. Recently, supplemental financial transaction systems have been developed that enable banks to support greater numbers of financial transactions without requiring a bank to upgrade its website and/or servers.

While supplemental financial transaction systems may enable banks to support a greater number of financial transactions, they do not currently provide a convenient means for generating global electronic funds transfers for international clients in countries outside the United States. Additionally, bank customers may be unfamiliar with the information required to perform an electronic funds transfer in a different country. For this reason, with regards to foreign countries, bank customers may enter information required to perform an electronic funds transfer in the wrong format.

Therefore, there exists a need for a supplemental financial transaction system that provides a means for generating a global electronic funds transfer.

### SUMMARY

The present invention provides a system for validating received clearing information (i.e., required information) for implementing a global electronic funds transfer.

A first aspect of the present invention relates to a global electronic funds payment system for validating received clearing information for implementing a funds transfer. The clearing information includes required information for performing the funds transfer. The system includes a processor, a network interface, and a database. The processor is configured to generate a form for receiving clearing information. The form includes clearing information fields, where each clearing information field is configured to receive clearing information. The network interface is configured to provide the form to a user and receive the clearing information from the user. The database is encoded to a non-transitory computer readable medium and includes at least one validation rule defining a relationship between at least one of the clearing information fields and the clearing information received from the user. The at least one validation rule specifies acceptable values for the clearing information received by a given clearing information field. The processor is further configured to analyze the clearing information received from the user in relation to the at least one clearing information field by applying the at least one validation rule in order to adjudicate the clearing information received in the given clearing information field as acceptable or invalid. The processor is also further configured to process the clearing information received in the given clearing information field as a function of whether adjudication is acceptable or invalid in order to update the form. The network interface is further configured to provide the updated form to the user.

Additionally or alternatively, the clearing information fields of the updated form adjudicated as invalid may be visibly marked as invalid on the form.

Additionally or alternatively, the clearing information includes at least one of payment method, payment type, and clearing method.

Additionally or alternatively, the clearing information includes the clearing method and the clearing method includes at least one of Canadian Electronic Funds Transfer (EFT), Australian Direct Entry, New Zealand Bulk Electronic Clearing System (BECS), United Kingdom (UK) Bankers' Automated Clearing Services (Bacs), and UK Faster Payments.

Additionally or alternatively, the Canadian Electronic Funds Transfer (EFT) is the clearing method, a specific clearing information field corresponds to a date, and the at least one validation rule specifies a date in a range of one hundred days before today to one hundred days after today as an acceptable value for clearing information received in the specific clearing information field.

Additionally or alternatively, the Canadian Electronic Funds Transfer (EFT) is the clearing method and the at least one validation rule specifies French characters as acceptable for clearing information received in the clearing information fields.

Additionally or alternatively, the Australian Direct Entry is the clearing method, a specific clearing information field corresponds to a date and the at least one validation rule specifies a week day date of today or in the future as an acceptable value for clearing information received in the specific clearing information field.

Additionally or alternatively, a specific clearing information field corresponds to an account number and the at least one validation rule specifies a particular format as an acceptable value for clearing information received in the specific clearing information field.

Additionally or alternatively, the particular format comprises at least one of a maximum number of characters, a minimum number of characters, and a list of acceptable characters.

Additionally or alternatively, the New Zealand Bulk Electronic Clearing System (BECS) is the clearing method, the particular format comprises a maximum number of characters, and the maximum number of characters is twenty.

Additionally or alternatively, the Canadian Electronic Funds Transfer (EFT) is the clearing method, the particular format comprises a maximum number of characters, and the maximum number of characters is twelve.

Additionally or alternatively, a user enters clearing information in a specific clearing information field using at least one of a drop down list, a drop down calendar, a text box, a check box, and a radio button.

Additionally or alternatively, the system implements an electronic funds transfer based on the clearing information.

Additionally or alternatively, the system provides the clearing information to a bank's transaction processing system for performing an electronic funds transfer based on the clearing information.

Additionally or alternatively, the funds transfer is an ACH payment.

Additionally or alternatively, the global electronic funds payment system is part of a supplemental financial transaction system.

Additionally or alternatively, the form comprises a user interface displayed to a user.

An other aspect of the present invention relates to a global electronic funds payment system for validating received clearing information for implementing a funds transfer. The clearing information includes required information for performing the funds transfer. The system includes a processor, a network interface, and a database. The processor is configured to generate a form for receiving clearing information. The form includes clearing information fields, each clearing information field configured to receive clearing information. At least one is clearing information field is configured to receive a clearing method. The network interface is configured to provide the form to a user and receive the clearing information from the user. The received clearing information includes a given clearing method. The database is encoded to a non-transitory computer readable medium. The database includes at least one validation rule defining a relationship between at least one of the clearing information fields and the clearing information received from the user. The at least one validation rule specifies acceptable values for the clearing information received by a given clearing information field based on the given clearing method. The processor is further configured to analyze the clearing information received from the user in relation to the at least one clearing information field by applying the at least one validation rule in order to adjudicate the clearing information received in the given clearing information field as acceptable or invalid. The processor is also further configured to process the clearing information received in the given clearing information field as a function of whether adjudication is acceptable or invalid in order to update the form. The network interface is further configured to provide the updated form to the user.

For a better understanding of the present invention, together with other and further aspects thereof, reference is made to the following description, taken in conjunction with the accompanying drawings. The scope of the invention is set forth in the appended claims, which set forth in detail certain illustrative embodiments. These embodiments are indicative, however, of but a few of the various ways in which the principles of the invention may be employed.

### BRIEF DESCRIPTION OF THE DRAWINGS

FIG. 1 is a block diagram of an exemplary system for receiving clearing information for implementing a funds transfer;

FIGS. 2A-2B are exemplary screen shots of a form and updating of the form based on validation rules;

FIG. 3 is a schematic diagram depicting a payment file;

FIGS. 4A-4G are schematic diagrams depicting exemplary validation rules stored in a database;

FIG. 5 is an exemplary screen shot of a form and updating of the form based on the validation rules of FIGS. 4A-4G; and

FIG. 6 is a block diagram depicting a method for validating received clearing information for implementing a funds transfer.

### DETAILED DESCRIPTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions which are encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a computer readable media, or a combination of a hardware circuit(s) and a processor and/or control block executing such code.

The present invention provides a system and method for validating received required information (i.e., clearing information) for implementing a funds transfer. For example, the system and method may be configured to receive required information for performing an in country payment in multiple different countries. The system and method generate a form for receiving the clearing information from a user. The form includes clearing information fields that are each configured to receive an element of clearing information. The form is updated based on validation rules. The validation rules (1) define a relationship between at least one of the clearing information fields and the clearing information received from the user and (2) specify acceptable values for the clearing information received by a given clearing information field. The received clearing information is analyzed in relation to the clearing information fields by applying the validation rules to adjudicate the clearing information received in the given clearing information field as acceptable or invalid. To update the form, the clearing information received in the given clearing information field is processed as a function of the adjudication. The updated form is provided to the user, e.g., to input further clearing information.

Turning to FIG. 1, an exemplary architecture 8 including a primary financial services system 10, a client system 14, and a supplemental financial transaction system 16 are shown. When operated by a user with applicable authentication credentials for the primary financial services system 10, the client system 14 may establish a secure connection 20 to a web server 22 of the primary financial services system 22 and obtain web access to entitled banking accounts maintained by, and services offered by, a financial institution operating the primary financial services system 22. A secure web application server 23 of the primary financial services system 22 may enable the client system to perform core function (e.g., viewing account balances, printing statements, etc.) However, the primary financial services system 22 may not support supplemental financial transactions (e.g., initiating wire transfers).

The supplemental financial transaction processing system 16 provides support for supplemental financial transactions that are not supported by the primary financial services system 22. That is, the supplemental financial transaction processing system 16 allows a user to perform supplemental financial transactions that are not supported by the primary financial services system 22.

An exemplary supplemental financial transaction system is further described in U.S. Pat. No. 7,805,370 filed on Apr. 29, 2009, the entire contents of which are incorporated by reference herein.

Again referring to FIG. 1, the supplemental financial transaction system 16 includes a global electronic funds payment system 22. The global electronic funds payment system 22 may provide functionality for receiving clearing information 24 for implementing a global electronic funds transfer. The global electronic funds payment system 22 may be a sub-system of the supplemental financial transaction system 16. The global electronic funds payment system 22 may be a computer system of one or more servers including at least a processor 26, a network interface 27, and computer readable medium 28. The computer readable medium 28 may include encoded thereon a database 29. The database 29 may include data structures, also referred to as tables, as described herein and may include instructions embodied on computer readable medium 28 for interfacing with the network interface 27 and for reading and writing data to the database 29.

The processor 26 may be configured to (1) generate a form 30 for accepting clearing information 24, (2) analyze the clearing information 24 received from the user, and (3) dynamically update the form 30. The processor 26 may generate the form 30 using an initial form template, one or more clearing information rules, or using any other suitable means.

Turning to FIG. 2A, an exemplary form 30 is depicted. The form 30 may comprise a user interface displayed to the user, a web page, a frame of a web page, an applet, an HTML form, or any other suitable means for receiving user-entered information. The form 30 includes at least one clearing information field 32. The at least one clearing information field 32 may comprise a textbox, a drop down list, a drop down calendar, a checkbox, a radio button, or any suitable field for receiving data entered by a user.

As depicted in the form 30 of FIG. 2B, upon selection of a clearing method 32 in FIG. 2A, the form 30 may be updated to include additional clearing information fields 32a-32d that may be grouped into sections 36. Updating the form is further described in U.S. patent application Ser. No. 13/833,602 filed on Mar. 15, 2013, the entire contents of which are incorporated by reference herein.

In FIG. 2B, upon selection of “AU-DE” as the clearing method in FIG. 2A, the form 30 is updated to include additional clearing information fields 32a-32d. In is the example, the user has entered clearing information in the clearing information fields relating to the direct entry ID 32a and the value date 32d of the funds transfer. The clearing information corresponding to the date has been entered as Jan. 26, 2013, a weekend. After applying validation rules, the clearing information field 32d relating to the value date is visibly marked 34 as invalid on the form 30.

The processor 26 may analyze the clearing information 24 received from the user in relation to the at least one clearing information field 32 by applying at least one validation rule 50 (FIGS. 4A and 4B) in order to adjudicate the clearing information received in a given clearing information field 32 as acceptable or invalid. Based on this analysis, in order to update the form, the processor 26 processes the clearing information received in the given clearing information field 32 as a function of whether adjudication is acceptable or invalid. For example, the processor 26 may be configured to update the form 30 by applying each validation rule 50 that is applicable based on the received clearing information 24. Updating the form may include, e.g., visibly marking 34 a clearing information field 32 as containing invalid clearing information, generating an audible notification, and/or visibly marking a clearing information field 32 as containing acceptable clearing information. Updating the form 30 may occur as the user enters clearing information 24. The network interface 27 may be configured to provide the updated form 30 to the user and, e.g., receive further clearing information 24.

As will be understood by one of ordinary skill in the art, the processor 26 may have various implementations. For example, the processor 26 may include any suitable device, such as a programmable circuit, integrated circuit, memory and I/O circuits, an application specific integrated circuit, microcontroller, complex programmable logic device, other programmable circuits, or the like. The processor 26 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor 26. Based on this disclosure, one of ordinary skill in the art would understand how to program the processor 26 to perform the steps described herein.

The network interface 27 may be communicatively coupled to the client system 14 and the primary financial services system 22 over, e.g., an open network (such as the Internet), a private network (such as a virtual private network), or any other suitable network. The network interface 27 may be configured to provide the form 30 to the user and receive clearing information 24 and primary system defined values 52 from the client system 22 and/or the primary financial services system 22.

As will be understood by one of ordinary skill in the art, the network interface 27 may comprise a wireless network adaptor, an Ethernet network card, or any suitable device that provides an interface between the system 22 and a network.

Turning to FIG. 3, the received clearing information 24 may be stored in the database 29. The clearing information 24 may be stored as payment files 60. Each element of received clearing information 24 may correspond to an element of required information relating to a particular global electronic funds transfer. Each payment file 60 may correspond to a global electronic funds transfer (e.g., a batch funds transfer) and may include a payment header 62 and at least one payment child 64. The clearing information 24 included in the payment header 62 may correspond to clearing information 24 that applies to each payment child 64a, 64b, 64c of the payment file 60.

For example, for a given payment file 60, the given payment file 60 may include clearing information 24 designating a foreign country. The clearing information 24 contained in the given payment file 60 may include all of the information required to initiate an electronic funds transfer to a bank in the foreign country.

For example, as depicted in FIG. 3, a payment file 60 may correspond to a batch funds transfer from an originator to multiple beneficiaries. The clearing information 24 relating to the originator (e.g., may include payment information 66, originator information 68, and default information 70) may be included in the payment file header and may be the same for each beneficiary in the batch funds transfer. However, the clearing information 24 relating to each beneficiary (e.g., payee information 72, payment details 74, and receiver information 76) may be different for each beneficiary and may be included in a separate payment child 64a, 64b, 64c of the payment file 60.

With reference to FIGS. 4A-4G, the at least one validation rule 50 may also be stored in the database 29. The database 29 may include multiple validation rules 50. For example, in FIG. 4A, the database 29 includes six exemplary validation rules 50a-50f. An exemplary validation rule 50 may specify, for a given clearing method, updating the form 50 to include a visible mark 34, indicating that the clearing information 24 received in a given clearing information field 32 is invalid or acceptable. Each validation rule 50a-50f, may include a Boolean statement 80 that, if true, results in the application of an action statement 82 that adjudicates the clearing information 24 as acceptable or invalid.

For example, in FIG. 4B, validation rule 001 50a is shown. In the validation rule 50a, the Boolean statement 80a is defined as “if clearing method≠CA-EFT & date==weekend”. If the Boolean statement 80a is true (i.e., if the clearing method is not CA-EFT, e.g., if the clearing method is AU-DE, and the entered date is a weekend), then the action statement 82a is performed. The action statement 82a specifies that the clearing information 24 (i.e., the date) is adjudicated as invalid and a visible mark stating “Invalid Date: Please select a weekday” is displayed. Application of validation rule 50b is depicted in FIG. 2B, where, e.g., clearing information corresponding to the value date is marked 34 as invalid. Further explanation of the validation rules in FIGS. 4C-4G is made below with reference to FIG. 5.

As will be understood by one of ordinary skill in the art, the validation rules 50 are not limited to a format comprising a Boolean statement and an action statement, but may take any suitable form.

As will be understood by one of ordinary skill in the art, the database 29 may describe a data structure which embodies groups of records or data elements stored in a volatile or non volatile storage medium and accessed by an application, which may be instructions coded to a storage medium and executed by a processor. The database 29 may comprise multiple individual databases stored on the same storage medium or on multiple different storage media. The system 22 may also store data in and access the database 29. While the database 29 is depicted as a component of the global electronic funds payment system in FIG. 1, the database 29 could alternatively be stored on a separate server or computer.

The client system 14 may comprise systems with a known operating system (not shown), known IP networking hardware and software (not shown), and a known secure hypertext transport protocol (e.g. HTTPS) client such as a web browser for establishing and maintaining, through an internet connection provided by an Internet Service Provider (not shown) secure (e.g. HTTPS) connections to servers with an exposed URL. The client system 14 may also include a display 15 for displaying the form 30 to the user and an input 17 for inputting clearing information 24 into the clearing information fields 32 by the user. The display 15 may comprise a monitor, a television, a tablet, a smart phone, or any other suitable object for displaying the form 50 to a user. The input 17 may comprise a keyboard, a touchscreen, a mouse, or any other suitable object for entering information into the clearing information fields 32.

In general, the primary financial services system 22 may comprise traditional internet banking application architecture wherein a secure web application server 23 interfaces between the web server 22 and the bank's back end account management and transaction processing systems 90.

In more detail, data obtained from the back end account management systems 90 may be populated into web pages provided to the client system 14 and transactions initiated through a client system 14 may be validated by the secure web application server 23. Processes performed by the application server 23 enabling an authenticated user to access his/her accounts may be referred to as core functions.

For example, the account management and transaction processing functions (e.g. the core functions) supported by the secure web application server 23 may consist of: i) viewing account balances, ii) viewing/printing statements; iii) transferring funds between accounts; and iv) limited payment functions such as scheduling the printing and mailing of a check drawn on an account and/or initiating Automated Clearing House (ACH) debit and credit transactions to accounts held by other United States based financial institutions.

In order to perform a supplemental financial transaction that is not supported by the primary financial services system 16, the application server 23 may direct a web services client 87 to initiate a request 88 for the supplemental transaction to the supplemental financial transaction system 16.

As described above, supplemental financial transaction services are transactions that are not supported by the financial services system 22—i.e., the web application server 23 does not include applicable systems for, e.g., obtaining user input of transaction values, populating a transaction template, validating the transaction, and/or posting the transaction to the appropriate back end systems 90. For example, the supplemental financial transactions may include initiating wire payments.

The request 88 for the supplemental transaction may include primary system defined values 52 representing a portion, or subset, of the values required for the supplemental transaction 92. More specifically, the primary system defined values 52 may include the values controlled by the financial institution (i.e., not the user) that are required to create a validated transaction of the type for which the method call was initiated. For example, in a case wherein the supplemental financial transaction is an ACH payment in a foreign country, the user's account number could be a value controlled by the financial institution.

In response to receiving the transaction request 88, the supplemental financial transaction system 16 may: i) assign a unique redirect URL 94 to the transaction request 88; ii) store, in association with the unique redirect URL 94, the primary system defined values 52 provided in the request 88; and iii) return the unique redirect URL 94 to the primary financial services system 22 in a response 96 to the request 88.

After receiving the response 96 to the transaction request 88, the primary financial services system 22 may provide a supplemental transaction web page 100 to the client system 14 through the secure session 30. The supplemented transaction web page 100 may comprise a supplemental transaction frame 102 and, in association with the supplemental transaction frame 102, the unique is redirect URL 94.

The global electronic funds payment system 22 provides a supplemental transaction web document object 106 for rendering within the supplemental transaction frame 102. The supplemental transaction web document object 106 may include the form 30 for accepting clearing information 24. The form 30, as described above, includes clearing information fields 32, with each clearing information field 32 configured to accept an element of clearing information 24.

The supplemental transaction web document object 106 may also include: i) the primary system defined values 52; ii) a script for rendering at least a portion of the primary system defined values 52 (in a locked or otherwise unchangeable field); iii) a script for rendering the form; iv) and a script for rendering controls for obtaining user entry of clearing information 24 in the clearing information 24 fields of the form. The supplemental transaction web document object 106 may be displayed in accordance with a look and feel matching that of web pages provided by the primary financial services system 22.

The global electronic funds payment system 22 receives the clearing information 24 entered (e.g., by the user) into the clearing information fields 32 and may store the clearing information 24 in the database 29.

Turning to FIG. 5, assuming the database 29 contains the validation rules 50 depicted in FIGS. 4A-4G, the system 22 receives clearing information 24 indicating that CA-EFT was selected as the clearing method, resulting in the generation of the form 30 in FIG. 5. After providing the form to the user, the user enters the clearing information 24 shown in clearing information fields relating to originator ID 32e, description 32f, destination currency 32g, value date 32i, and customer account number 32k. As the clearing information 24 is entered into the clearing information fields 32e, 32f, 32g, 32i, 32k, the clearing information 24 is received by the system 10.

The processor 26 analyzes the clearing information 24 received from the user in relation to the clearing information fields 32 by applying the validation rules 50a-50f. The processor 26 applies validation rule 002 50b, because the Boolean statement 80b is true for the received clearing information 24 and the clearing information fields 32 that accepted the clearing information 24. Thus, as specified is in the action statement 82b, the date is adjudicated as acceptable and the entered date is accepted (e.g., stored in a payment file 60). The processor does not apply validation rule 001 50a and rule 004 50d, because the Boolean statements 80a, 80d are not true for the received clearing information 24 (i.e., the clearing method is CA-EFT).

The processor 26 also applies validation rule 003 50c and rule 005 50e, because the Boolean statements 80c, 80e are true for the received clearing information 24 and the clearing information fields 32 that accepted the clearing information 24. Thus, as specified in the action statement 80c for rule 003 50c, the French characters entered into the description are adjudicated as acceptable and the entered description is accepted (e.g., stored in a payment file 60). Also, as specified in the action statement 80e for rule 005 50e, the account number entered is adjudicated as invalid (i.e., the account number is greater than twelve characters in length) and the clearing information 24 is marked as invalid 34. The processor does not apply validation rule 006 50f, because the Boolean statement 80f is not true for the received clearing information 24 (i.e., the clearing method is not NZ-BECS).

As described previously, the clearing information 24, e.g., may relate to payment information, originator information, default information, and beneficiary information. The payment information may include payment method, a payment type, and a clearing method. The clearing method may comprise Canadian Electronic Funds Transfer (EFT), Australian Direct Entry, New Zealand Bulk Electronic Clearing System (BECS), United Kingdom (UK) Bankers' Automated Clearing Services (Bacs), or UK Faster Payments. The originator information may include, e.g., at least one of an originator ID/name, an originator description, a DD code, a direct entry ID, a value date, hours, a batch name, a funds account number, a funds account name, a dishonours account number, a dishonours account name, a funds BSB, a funding method, a destination currency, a reporting method, a statement reference, a statement narrative, and an internal memo. The default information may include, e.g., at least one of an originator code, originator particulars, an originator reference, a payee code, payee particulars, a payee reference, a transaction code, a transaction description, a date, a transaction code, a transaction description, a remitter name, a trade account number, a trade account name, a trace BSB, a lodgement reference, and a default description. The beneficiary information may include payee information.

After receiving the clearing information 24, the global electronic funds payment system 22 may implement a global electronic funds transfer based on the clearing information 24. Implementing the global electronic funds transfer may comprise providing the clearing information 24 to a bank's transaction processing system for performing the global electronic funds transfer based on the clearing information. The electronic funds transfer may, e.g., comprise an ACH payment or a wire transfer.

Turning to FIG. 6, exemplary method steps for validating received clearing information for implementing the funds transfer are shown. The steps may be performed, e.g., in response to a user making a request to perform a global electronic funds transfer. In process block 112, a form 30 is generated including clearing information fields 32. After the form 30 has been generated, in process block 114, the form 30 is provided to a user. The user may enter clearing information 24 into the clearing information fields 32 of the form 30. In process block 116, the clearing information 24 from the user is received. An element of the clearing information is selected in process block 118.

In process block 120, the element of clearing information 24 is analyzed in relation to the validation rules 50. In process block 122, for each validation rule 50 that applies, the validation rule 50 is applied in order to adjudicate the clearing information 24 received in the given clearing information field 32 as acceptable or invalid. In process block 124, to update the form, the clearing information 24 received in the given clearing information field 32 is processed as a function of whether adjudication is acceptable or invalid.

In decision block 128, if any elements of clearing information 24 have not been analyzed, another element of clearing information 24 is selected. However, if all elements of clearing information 24 have been analyzed, in process block 130, the dynamically updated form 30 is supplied to the user.

It is envisioned that after reading and understanding the present invention those skilled in the art may envision other processing states, events, and processing steps to further the objectives of the modular multi-media communication management system of the present invention. The present invention includes all such equivalents and modifications, and is limited only by the scope of the following claims.

What is claimed is:

1. A global electronic funds payment system for validating received clearing information for implementing a funds transfer, the clearing information comprising required information for performing the funds transfer, the system comprising:
a processor configured to generate a form for receiving clearing information, the form including clearing information fields, each clearing information field configured to receive clearing information;
a network interface configured to provide the form to a user and receive the clearing information from the user;
a database encoded to a non-transitory computer readable medium, the database including at least one validation rule defining a relationship between at least one of the clearing information fields and the clearing information received from the user, the at least one validation rule specifying acceptable values for the clearing information received by a given clearing information field;
the processor further configured to analyze the clearing information received from the user in relation to the at least one clearing information field by applying the at least one validation rule in order to adjudicate the clearing information received in the given clearing information field as acceptable or invalid, and processing the clearing information received in the given clearing information field as a function of whether adjudication is acceptable or invalid in order to update the form; and
the network interface further configured to provide the updated form to the user.

2. The global electronic funds payment system of claim 1, wherein the clearing information fields of the updated form adjudicated as invalid are visibly marked as invalid on the form.

3. The global electronic funds payment system of claim 1, the clearing information comprising at least one of payment method, payment type, and clearing method.

4. The global electronic funds payment system of claim 3, the clearing information comprising the clearing method and the clearing method comprising at least one of Canadian Electronic Funds Transfer (EFT), Australian Direct Entry, New Zealand Bulk Electronic Clearing System (BECS), United Kingdom (UK) Bankers' Automated Clearing Services (Bacs), and UK Faster Payments.

5. The global electronic funds payment system of claim 4, wherein Canadian Electronic Funds Transfer (EFT) is the clearing method, a specific clearing information field corresponds to a date, and the at least one validation rule specifies a date in a range of one hundred days before today to one hundred days after today as an acceptable value for clearing information received in the specific clearing information field.

6. The global electronic funds payment system of claim 4, wherein Canadian Electronic Funds Transfer (EFT) is the clearing method and the at least one validation rule specifies French characters as acceptable for clearing information received in the clearing information fields.

7. The global electronic funds payment system of claim 4, wherein Australian Direct Entry is the clearing method, a specific clearing information field corresponds to a date and the at least one validation rule specifies a week day date of today or in the future as an acceptable value for clearing information received in the specific clearing information field.

8. The global electronic funds payment system of claim 4, wherein a specific clearing information field corresponds to an account number and the at least one validation rule specifies a particular format as an acceptable value for clearing information received in the specific clearing information field.

9. The global electronic funds payment system of claim 8, wherein the particular format comprises at least one of a maximum number of characters, a minimum number of characters, and a list of acceptable characters.

10. The global electronic funds payment system of claim 9, wherein New Zealand Bulk Electronic Clearing System (BECS) is the clearing method, the particular format comprises a maximum number of characters, and the maximum number of characters is twenty.

11. The global electronic funds payment system of claim 9, wherein Canadian Electronic Funds Transfer (EFT) is the clearing method, the particular format comprises a maximum number of characters, and the maximum number of characters is twelve.

12. The global electronic funds payment system of claim 1, wherein a user enters clearing information in a specific clearing information field using at least one of a drop down list, a drop down calendar, a text box, a check box, and a radio button.

13. The global electronic funds payment system of claim 1, wherein the system implements an electronic funds transfer based on the clearing information.

14. The global electronic funds payment system of claim 1, wherein the system provides the clearing information to a bank's transaction processing system for performing an electronic funds transfer based on the clearing information.

15. The global electronic funds payment system of claim 1, wherein the funds transfer is an ACH payment.

16. The global electronic funds payment system of claim 1, wherein the global electronic funds payment system is part of a supplemental financial transaction system.

17. The global electronic funds payment system of claim 1, wherein the form comprises a user interface displayed to a user.

18. A global electronic funds payment system for validating received clearing information for implementing a funds transfer, the clearing information comprising required information for performing the funds transfer, the system comprising:
a processor configured to generate a form for receiving clearing information, the form including clearing information fields, each clearing information field configured to receive clearing information, at least one clearing information field configured to receive a clearing method;
a network interface configured to provide the form to a user and receive the clearing information from the user, the received clearing information including a given clearing method;
a database encoded to a non-transitory computer readable medium, the database including at least one validation rule defining a relationship between at least one of the clearing information fields and the clearing information received from the user, the at least one validation rule specifying acceptable values for the clearing information received by a given clearing information field based on the given clearing method;
the processor further configured to analyze the clearing information received from the user in relation to the at least one clearing information field by applying the at least one validation rule in order to adjudicate the clearing information received in the given clearing information field as acceptable or invalid, and processing the clearing information received in the given clearing information field as a function of whether adjudication is acceptable or invalid in order to update the form; and
the network interface further configured to provide the updated form to the user.
